(19) United States
(12) Patent Application Publication
(10) Pub. No.: US 2022/0254520 A1
(43) Pub. Date: Aug. 11, 2022

(54) INERTIAL ELECTROSTATIC CONFINEMENT FUSION FACILITY HAVING INNER ION SOURCE

(71) Applicant: Pan-China Detection Technology Co. Ltd, Nanchang (CN)

(72) Inventors: Jinhai LI, Nanchang (CN); Dan LIU, Nanchang (CN)

(21) Appl. No.: 17/728,796

(22) Filed: Apr. 25, 2022

Related U.S. Application Data
(63) Continuation of application No. PCT/CN2021/072971, filed on Jan. 21, 2021.

(30) Foreign Application Priority Data
Mar. 3, 2020 (CN) 202010138339.3

(51) Int. Cl. G21B 1/03; G21B 1/05

(52) U.S. Cl. CPC G21B 1/03; G21B 1/05

(57) ABSTRACT

An inertial electrostatic confinement (IEC) fusion facility with inner ion source includes an anode, a cathode, a high-voltage lead-in support rod connected to the cathode, an inner ion source, a vacuum system, and a high-voltage system. An anode potential of the inner ion source is lower than an anode potential of the IEC; the cathode is a spherical net structure having longitude and latitude circles, and cooling channels are arranged in the longitude and latitude circles. An ion motion trajectory perturbation device (IMTPD) is arranged in the IEC for performing perturbation to change an angular momentum of an ion motion. IMTPD can avoid the ion loss for the long time confinement when the ion move back and forth in IEC. The high vacuum can avoid the ion loss and the power consume of high voltage source induced by the ionization. A neutron yield and a gain-loss ratio can be improved.

### CROSS-REFERENCE TO RELATED APPLICATIONS

This application is a continuation of International Patent Application No. PCT/CN2021/072971 with a filing date of Jan. 21, 2021, designating the United States, now pending, and further claims priority to Chinese Patent Application No. 202010138339.3 with a filing date of Mar. 3, 2020. The content of the aforementioned applications, including any intervening amendments thereto, are incorporated herein by reference.

### TECHNICAL FIELD

The present invention relates to the nuclear fusion and neutron source technologies, and more particularly, to an inertial electrostatic confinement fusion facility having an inner ion source.

### BACKGROUND

At present, nuclear fusion technologies mainly comprise four categories: Tokamak, laser inertial confinement, Z pinch and inertial electrostatic confinement, and these technologies have their own advantages and disadvantages. An inertial electrostatic confinement facility has a smallest size and smallest power consumption, without a fusion ignition problem and a complicated plasma dynamics problem, and the main disadvantages of the facility are that a neutron yield is relatively low and there is a large distance to reach energy gain-loss balance. At present, neutron sources are mainly divided into a radioisotope neutron source and an accelerator neutron source. There are many types of accelerator neutron sources, comprising a self-sealing neutron tube, and neutron sources based on large-scale accelerators, such as a high voltage accelerator, a cyclotron, a synchrotron and a linac. The inertial electrostatic confinement facility may also be regarded as the accelerator neutron source. Although the neutron yield of the inertial electrostatic confinement facility is lower than that of the large-scale accelerator neutron source, the neutron yield of the inertial electrostatic confinement facility is generally higher than that of the self-sealing neutron tube.

At present, an input electric power of the inertial electrostatic confinement facility ranges from several hectowatts to several kilowatts, a maximum neutron yield reaches a magnitude of 10⁸ n/s, and a working pressure ranges from several Pa to 10⁻² Pa. For a power input of 1 kW, a deuterium neutron yield reaches a magnitude of about 10¹⁵ n/s in the case of reaching the energy gain-loss balance. Therefore, how to reduce the electric power input and increase the neutron yield of the facility is a key problem to be solved to reach the gain-loss balance.

The electric power input by the inertial electrostatic confinement facility is mainly consumed in an electron flow generated by ionized working gas. Although ionized deuterium ions may oscillate back and forth in the facility, electrons move to an anode as soon as being generated so as to be lost, thus forming a loss current. Therefore, Kajiwara et al. of Japan put forward a solution of using a double-spherical net electrode, which means that an outermost vacuum isolated metal sphere is grounded, a middle metal spherical net is connected with a positive high voltage, and an innermost metal spherical net is grounded or connected with a negative high voltage. In this way, most of electrons ionized in the middle spherical net oscillate back and forth around the middle spherical net, thus greatly reducing the loss current. However, due to the existence of the middle spherical net, some electrons will always be lost on the middle spherical net. In addition, accelerated deuterium ions obtained by ionization may capture electrons to recombine into deuterium atoms, and most of the deuterium atoms collide with an outer vacuum cavity wall without constraint so as to lose energy. However, this solution can reduce the input electric power of the inertial electrostatic confinement facility from several kilowatts to several hectowatts, but the neutron yield of the inertial electrostatic confinement facility is also decreased by ⅓ at the same time.

In order to improve the efficiency of nuclear fusion, the Institute of Nuclear Fusion, University of Wisconsin, USA put forward that an external ion source is used to inject He-3 ions into the inertial electrostatic confinement facility. However, due to the limitation of structure and principle, the He-3 ions can only pass through the inertial electrostatic confinement facility once, thus having very lower utilization efficiency. The reason is that an anode potential of the external ion source is higher than a ground potential, while a cathode potential of the ion source is equal to the ground potential. In this way, when the He-3 ions penetrate through a cathode of a spherical net structure of the inertial electrostatic confinement facility and move to the outermost vacuum cavity wall, a motion speed of the ions is equal to or close to a lead-out speed from the ion source, which cannot be reduced to zero, so that the motion of the He-3 ions cannot be confined and the He-3 ions are lost. In addition, there is a very large loss of ion beam current moving in the inertial electrostatic confinement facility, when the ion beam current moves back and forth in a straight line for one time, only about 4% of the injected beam current remains. Therefore, it is difficult for the initially injected ion beam to move back and forth for many times. The loss of the ion beam during motion mainly lies in an ionization loss of the ion beam with background gas, ion energy is mainly emitted in forms of electromagnetic radiation and heat energy, and energy involved in nuclear reaction only accounts for less than one billionth of the total energy.

In conclusion, it is difficult to improve the neutron yield of the inertial electrostatic confinement facility and reach the gain-loss balance due to the above reasons.

### SUMMARY

Aiming at the defects in the prior art, the present invention aims to provide an inertial electrostatic confinement fusion facility having an inner ion source to improve a neutron yield and a gain-loss ratio of the fusion facility.

The technical solutions of the present invention are as follows: an inertial electrostatic confinement fusion facility having an inner ion source comprises an anode, a cathode, a high-voltage lead-in support rod connected to the cathode, an inner ion source, a vacuum system, and a high-voltage power supply system, wherein an anode potential of the inner ion source is lower than an anode potential of the inertial electrostatic confinement fusion facility; and an ion motion trajectory perturbation device is arranged in the inertial electrostatic confinement fusion facility, and is used for performing perturbation to change an angular momentum of an ion motion.

Further, according to the inertial electrostatic confinement fusion facility having the inner ion source above, the cathode is a spherical net structure having longitude and latitude circles, and connected with a negative high voltage through the high-voltage lead-in support rod; and the anode of the inertial electrostatic confinement fusion facility is grounded as a vacuum cavity wall, or the anode is a spherical net structure, connected with a positive high voltage, and arranged in a larger grounded vacuum cavity wall.

Further, according to the inertial electrostatic confinement fusion facility having the inner ion source above, the ion motion trajectory perturbation device is an electric field perturbation device or a magnetic field perturbation device; the electric field perturbation device is a metal plate connected to the anode of the inertial electrostatic confinement fusion facility; and the magnetic field perturbation device is a magnet capable of generating a small-area magnetic field, and a magnetic field action area is generally smaller than a volume of the cathode of the spherical net structure, and located close to the anode. The ion motion trajectory perturbation device is located in a symmetrical position or slightly deviated symmetrical position on the inner ion source relative to a center of the cathode of the inertial electrostatic confinement fusion facility.

Further, according to the inertial electrostatic confinement fusion facility having the inner ion source above, an angular momentum of ions injected through the inner ion source is capable of changing from a zero angular momentum to a non-zero angular momentum, or changing from the non-zero angular momentum to a reverse angular momentum or the zero angular momentum; and if the angular momentum of the injected ions is the zero angular momentum, and the electric field perturbation device is used at the same time, the electric field perturbation device needs to be located in the slightly deviated symmetrical position on the inner ion source relative to the center of the cathode of the inertial electrostatic confinement fusion facility.

Further, according to the inertial electrostatic confinement fusion facility having the inner ion source above, the cathode is the structure having longitude and latitude circles, which has advantages of a simple structure and an arrangement favorable for circulating cooling channels. At least one longitude circle of the same size is provided; and the latitude circles are symmetrical in upper and lower hemispheres, more than four latitude circles are provided, and when an even number of latitude circles are provided, no latitude circle is arranged in an equator position of the cathode of the spherical net structure. Cross sections of the longitude circle and the latitude circle are in a rectangle, a long edge direction of the rectangle is a radial direction pointing to a center of sphere, and a short edge direction of the rectangle is perpendicular to the radial direction. An advantage of the rectangular cross sections is that when a cross-sectional area of the cooling channels and a heat-dissipation area of grids are increased, an interception rate of ions is not increased, so that a temperature and a corrosion effect of the cathode of the spherical net structure can be reduced.

Further, according to the inertial electrostatic confinement fusion facility having the inner ion source above, cooling channels are arranged in the longitude and latitude circles of the cathode; the cooling channel in the longitude circle is separated at a joint with the high-voltage lead-in support rod, and two ends separated are respectively connected with cooling medium input and output channels arranged in the high-voltage lead-in support rod; and the cooling channel in the latitude circle is communicated with the cooling channel in the longitude circle, and cross-sectional sizes of the cooling channels in different latitude circles are the same or different, for example, the farther the cooling channels in the latitude circles are from the high-voltage lead-in support rod, the smaller the cross sections of the cooling channels are, so as to facilitate flow distribution of the cooling medium. The cooling medium may be gas or liquid.

Further, according to the inertial electrostatic confinement fusion facility having the inner ion source above, the inner ion source is arranged in the anode of the inertial electrostatic confinement fusion facility, or arranged outside the anode of the inertial electrostatic confinement fusion facility. When the inner ion source is arranged outside the anode of the inertial electrostatic confinement fusion facility, the cathode of the inner ion source needs to penetrate through the anode of the inertial electrostatic confinement fusion facility and extend into the inertial electrostatic confinement fusion facility to inject an ion beam, and a focusing magnet is added outside the cathode of the inner ion source located outside the anode of the inertial electrostatic confinement fusion facility.

Further, according to the inertial electrostatic confinement fusion facility having the inner ion source above, the inner ion source is arranged on a plane perpendicular to the high-voltage lead-in support rod and passing through a center of the inertial electrostatic confinement fusion facility.

Further, according to the inertial electrostatic confinement fusion facility having the inner ion source above, a vacuum degree of a vacuum cavity is better than 10⁻³ Pa.

Further, according to the inertial electrostatic confinement fusion facility having the inner ion source above, a plurality of inner ion sources and a plurality of ion motion trajectory perturbation devices are provided separately or simultaneously.

The beneficial effects of the present invention are as follows: according to the inertial electrostatic confinement fusion facility having the inner ion source provided by the present invention, an inner ion source technique is used to confine a reciprocating motion of ions in the facility for a long time, the ion motion trajectory perturbation device is used to change the angular momentum of the ion motion, which may avoid an ion loss caused by returning ions to an ion source, thus prolonging an oscillation period of ions in the inertial electrostatic confinement fusion facility, and a high vacuum environment is used to avoid an ion loss and a high-voltage power-source loss caused by ionization. The cathode is the spherical net structure having longitude and latitude circles in which the cooling channels are arranged, which can reduce the working temperature of the cathode of the spherical net structure, thus avoiding melting of the cathode. As accumulated ions can be injected into the facility for a long time, a neutron yield and a gain-loss ratio can be improved.

### BRIEF DESCRIPTION OF THE DRAWINGS

FIG. 1 is a schematic structural diagram of an inertial electrostatic confinement fusion facility having an intracavity ion source of zero angular momentum injection in an embodiment of the present invention;

FIG. 2 is a schematic structural diagram of an inertial electrostatic confinement fusion facility having an extra cavity ion source of non-zero angular momentum injection in an embodiment of the present invention;

FIG. 3 is a schematic diagram of a cathode of a spherical net structure having longitude and latitude circles in which cooling channels are arranged; and

FIG. 4 is a schematic cross-sectional diagram along the longitude circle of the cathode in FIG. 3.

### DETAILED DESCRIPTION

The present invention is described in detail hereinafter with reference to the drawings and the embodiments.

The present invention provides an inertial electrostatic confinement fusion facility having an inner ion source, which comprises an anode, a cathode, a high-voltage lead-in support rod connected to the cathode, an inner ion source, a vacuum system, and a high-voltage system. An inner ion source technique is used in the facility, an ion motion trajectory perturbation device is arranged at the same time, and a perturbation electric field or magnetic field is used to change an oscillation trajectory of ions, so that an oscillation period of the ions is prolonged in the inertial electrostatic confinement facility, thus improving a neutron yield and a gain-loss ratio. The so-called inner ion source refers to that an anode potential of the ion source is lower than an anode potential of the inertial electrostatic confinement facility, and the ion source is not necessarily arranged in the anode of the inertial electrostatic confinement facility. In order to improve a collision probability, multiple inner ion sources may be used. In addition, in order to reduce an ionization loss of ions moving in the inertial electrostatic confinement facility, a vacuum degree in a vacuum cavity is as high as possible, and needs to be greater than 10⁻³ Pa. A fusion reaction mainly occurs close to the cathode of the inertial electrostatic confinement facility in which a beam current injected by the ion source oscillates back and forth. The ions oscillating back and forth collide, if large angle scattering occurs instead of the nuclear reaction, the scattered ions may be confined by the inertial electrostatic confinement facility, so that the ions oscillate back into a spherical net of the cathode again, and participate in nuclear fusion again. According to an angular momentum of ion injection by the ion source and a type of the ion motion trajectory perturbation device, a perturbation electric field or magnetic field may be located in a symmetrical position or slightly deviated symmetrical position on the inner ion source relative to a center of the cathode of the inertial electrostatic confinement fusion facility, with a function of changing an angular momentum of an injected beam current relative to the center of the inertial electrostatic confinement facility, thus avoiding the returned ions from colliding with the ion source or returning to the anode of the ion source. The injected ions may be changed from a zero angular momentum to a non-zero angular momentum by perturbation, or changed from the non-zero angular momentum to the zero angular momentum by perturbation. Certainly, the angular momentums before and after perturbation may both be non-zero.

### Embodiment 1

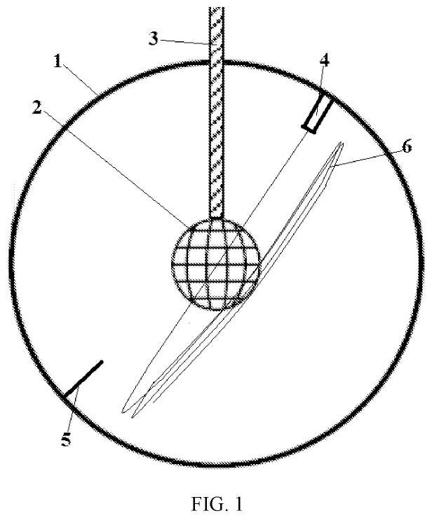

FIG. 1 shows an implementation that an inner ion source 4 is arranged in an anode 1 of an inertial electrostatic confinement facility. The anode 1 may be grounded as a vacuum cavity wall, or is a spherical net structure, connected with a positive high voltage, and arranged in a larger grounded vacuum cavity wall. A cathode 2 of the inertial electrostatic confinement facility is a spherical net structure, and generally connected with a negative high voltage through a high-voltage lead-in support rod 3. The high-voltage lead-in support rod 3 is insulated from the anode 1 and the vacuum cavity wall (if any). In order to avoid an adverse effect of the high-voltage lead-in support rod 3 on an ion motion, the inner ion source 4 may be arranged on a plane perpendicular to the high-voltage lead-in support rod 3 and passing through a center of the inertial electrostatic confinement facility, and an ion motion trajectory 6 in FIG. 1 may also be in this plane. An ion motion trajectory perturbation device 5 may be a metal plate connected to the anode of the inertial electrostatic confinement facility, or a magnet located in the inertial electrostatic confinement facility and capable of generating a small-area magnetic field, and a magnetic field action area is generally smaller than a volume of the cathode of the spherical net structure, and located close to the anode.

An ion beam led out from the inner ion source 4 moves at an accelerated speed to a center of the cathode 2 of the inertial electrostatic confinement facility, and after penetrating through a spherical net of the cathode, the ions move at a decelerated speed. Without the ion motion trajectory perturbation device 5, an electric field formed by the anode 1 of the inertial electrostatic confinement facility is a spherical central force field, and the ions move linearly in an opposite direction after decelerating to zero, and may return to the ion source in an ideal state. However, affected by a space charge force and a distorted electric field of the spherical net of the cathode, a large number of ions may be lost on the cathode and the anode of the inner ion source, thus greatly affecting an utilization efficiency and a gain-loss ratio of the ions.

If the ion motion trajectory perturbation device 5 is an electric field perturbation device (which may be the metal plate connected to the anode of the inertial electrostatic confinement facility), and completely symmetrical with the inner ion source 4 relative to the center of the cathode 2 of the inertial electrostatic confinement facility, the ions cannot be affected by a circumferential electric field component force perpendicular to a motion direction of the ions during decelerated motion, so that there is no change in angular momentum, and the ions can only return linearly according to an original path. If the electric field perturbation device 5 slightly deviates from a central symmetrical position, the circumferential electric field component force may be provided for the ions, thus changing the angular momentum of the ion motion.

A closed motion trajectory of the ions of the non-zero angular momentum in the central force field is in an ellipse, so that the ions returned for the first time may move to a right side of the ion source 4 in FIG. 1. The ion source 4 is wrapped by metal connected to the anode 1, which may provide a reverse angular momentum to the ions, so that the ions may move back and forth along a half ellipse. An actual ion motion trajectory is affected by the space charge force and the distorted electric field of the spherical net, which cannot be a standard semi-elliptical motion, but can only be a similar semi-elliptical motion.

If a circumferential force provided by the electric field perturbation device 5 is large enough, an elliptical ion motion trajectory with a low eccentricity may be formed, which means that, a difference between long and short axes of the ellipse is smaller, and such elliptical motion may avoid collision with the ion source, thus forming a complete elliptical motion. With the increase of number of ion cyclotron motions, the ellipse may be rounder, and distances from the trajectory to the ion source 4 and the electric field perturbation device 5 are also larger at the same time, until distortion of the electric field affecting on the ion motion trajectory is very small.

In a plane of the ion motion, a plurality of ion sources 4 and ion motion trajectory perturbation devices 5 may also be arranged, and the ion motion trajectories generated by different ion sources are easy to cross, thus increasing a probability of nuclear fusion. Since high vacuum or even extremely high vacuum is used in the inertial electrostatic confinement facility, a probability of collision with background gas during the ion motion is very small, and there is only a possibility of collision with the cathode 2. As long as the ion motion trajectory is designed reasonably and the cathode has a high transmittance, the ions may move for a long time.

### Embodiment 2

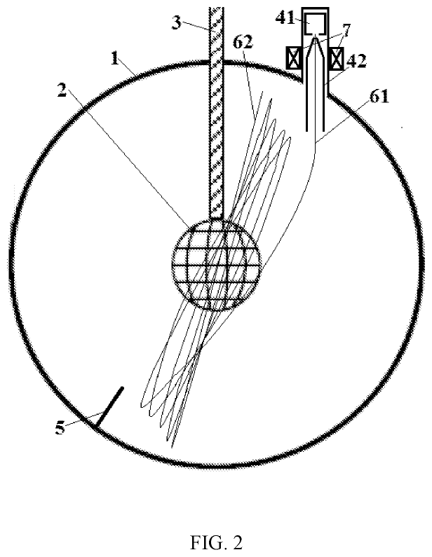

FIG. 2 shows an implementation that an inner ion source 4 is arranged outside an anode 1 of an inertial electrostatic confinement facility. An opening is formed in a sphere of the anode 1 of the inertial electrostatic confinement facility, and ions are injected into the inertial electrostatic confinement facility through the opening. Potentials of the plasma of the inner ion source and the anode 41 of the inner ion source are lower than the potential of the anode 1 of the inertial electrostatic confinement facility. A cathode 42 of the inner ion source is connected with a hollow cylinder and inserted into the anode 1 of the inertial electrostatic confinement facility, with an insertion depth that the potential of the inertial electrostatic confinement facility is equal to the potential of the cathode 42 of the inner ion source in position when the cathode is not inserted. Certainly, the depth may be adjusted as long as ion beam injection is not affected. Magnetic field focusing may also be added outside a cathode cylinder 42 of the ion source located outside the anode 1 of the inertial electrostatic confinement facility by setting a focusing magnet 7, thus improving a performance of beam current motion. The inner ion source 4 in FIG. 2 may be an ion source with a higher output current intensity.

An ion beam of a non-zero angular momentum is injected in FIG. 2. When the beam current moves to an ion motion trajectory perturbation device 5 for the first time, if an angular momentum of ions is directly reduced to zero, in the case that the ions linearly move to a side of the inner ion source, whether the ion source changes the angular momentum or not, the ion motion trajectory perturbation device 5 greatly affects the ion motion in subsequent motion, so that a reverse angular momentum may only be larger. Therefore, a stable motion state of the ions is a similar elliptical motion. If the ion motion trajectory perturbation device 5 only changes the angular momentum of the ions slightly, which means that an angular momentum of each cyclotron motion is reduced by a small magnitude, and the reduction is more and more slight, for example, the angular momentum reduced each time is ½ of the angular momentum of this cyclotron motion. In this way, the ion motion trajectory is closer to a linear motion, until the ions cannot be affected by a distorted electric field caused by the ion motion trajectory perturbation device 5. In FIG. 2, a first incident ion motion trajectory 61 has a large angular momentum, and an angular momentum of a final motion trajectory 62 is close to zero. Moreover, a linear motion with a zero angular momentum may generate a large number of ion collisions.

If the ion motion trajectory perturbation device is a magnetic field perturbation device, a magnetic field action area is generally smaller than a volume of the cathode of the spherical net structure, and located close to the anode. Under an action of a magnetic field, ions injected by a zero momentum may become ions of a non-zero momentum; while ions injected by the non-zero momentum are generally difficult to become ions of the zero momentum.

### Embodiment 3

The embodiment may be used in an implementation that an inner ion source is arranged inside an anode of an inertial electrostatic confinement facility, and may also be used in an implementation that the inner ion source is arranged outside the anode of the inertial electrostatic confinement facility. A main feature lies in that a cathode is a spherical net structure having longitude and latitude circles in which cooling channels are arranged, thus reducing a working temperature of the cathode of the spherical net structure.

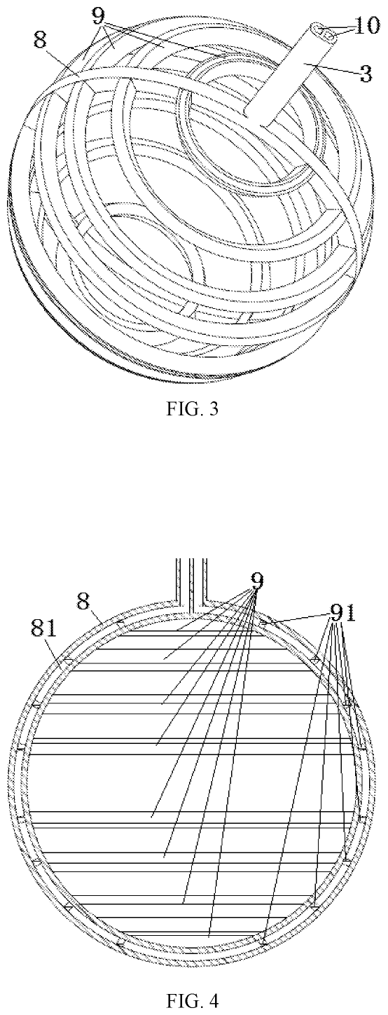

FIG. 3 shows the cathode of the spherical net structure having the longitude and latitude circles in which the cooling channels are arranged. There are two cooling medium channels 10 inside a high-voltage lead-in support rod 3, which are respectively used for input and output of a cooling medium. The cathode of the spherical net structure comprises one longitude circle 8 and eight latitude circles 9. The longitude circle 8 and the latitude circles 9 are all a rotator with a cross section in a rectangle, a long edge direction of the rectangle is a radial direction, and a short edge direction of the rectangle is perpendicular to the radial direction.

FIG. 4 is a cross-sectional view along the longitude circle in FIG. 3. The cooling channel 81 in the longitude circle is a main channel of a cooling channel loop, and the cooling channels 91 in the latitude circles are branch channels of the cooling channel loop. The cooling channel 81 in the longitude circle is separated at a joint with the high-voltage lead-in support rod 3, and two ends separated are respectively connected with cooling medium input and output channels arranged in the high-voltage lead-in support rod. The cooling channels in the latitude circles are communicated with the cooling channel in the longitude circle, and cross-sectional sizes of the cooling channels in different latitude circles are the same or different. As an implementation, the cross-sectional sizes of the cooling channels in different latitude circles shown in FIG. 4 are the same, but may also be designed to other types, for example, the farther the cooling channels in the latitude circles are from the high-voltage lead-in support rod, the smaller the cross sections of the cooling channels are, so as to facilitate flow distribution. The cooling medium in the cooling channels may be gas or liquid, and may be circulated through a cooling medium injection system.

The cathode of the spherical net structure of the embodiment is provided with only one longitude circle. As an alternative, the longitude circle is not limited to one, which means that a plurality of main channels of the cooling channel loop may be formed, and flow in parallel. However, the more the longitude circles are, the more difficult the design of the cooling channels is. Therefore, if the cooling channels are arranged in grids of the cathode of the spherical net structure, it is better to design one longitude circle. The latitude circles comprise but are not limited to a form of being symmetrical in upper and lower hemispheres, more than four latitude circles are provided generally, and when an even number of latitude circles are provided, no latitude circle is arranged in an equator position of the cathode of the spherical net structure.

Obviously, those skilled in the art may make various modifications and variations to the present invention without departing from the spirit and scope of the present invention. Therefore, if these modifications and variations of the present invention fall within the scope of the claims of the present invention and their equivalents, the present invention is also intended to comprise these modifications and variations.

What is claimed is:

1. An inertial electrostatic confinement fusion facility having an inner ion source, comprising an anode (1), a cathode (2), a high-voltage lead-in support rod (3) connected to the cathode (2), an inner ion source (4), a vacuum system, and a high-voltage power supply system, wherein an anode potential of the inner ion source (4) is lower than an anode potential of the inertial electrostatic confinement fusion facility; and an ion motion trajectory perturbation device (5) is arranged in the inertial electrostatic confinement fusion facility, and is used for performing perturbation to change an angular momentum of an ion motion.

2. The inertial electrostatic confinement fusion facility having the inner ion source according to claim 1, wherein the cathode (2) is a spherical net structure having longitude and latitude circles, and connected with a negative high voltage through the high-voltage lead-in support rod (3); and the anode (1) of the inertial electrostatic confinement fusion facility is grounded as a vacuum cavity wall, or the anode (1) is a spherical net structure, connected with a positive high voltage, and arranged in a larger grounded vacuum cavity wall.

3. The inertial electrostatic confinement fusion facility having the inner ion source according to claim 1, wherein the ion motion trajectory perturbation device (5) is an electric field perturbation device or a magnetic field perturbation device; the electric field perturbation device is a metal plate connected to the anode of the inertial electrostatic confinement fusion facility; the magnetic field perturbation device is a magnet capable of generating a small-area magnetic field, and a magnetic field action area is generally smaller than a volume of the cathode of the spherical net structure, and located close to the anode; and the ion motion trajectory perturbation device (5) is located in a symmetrical position or slightly deviated symmetrical position on the inner ion source (4) relative to a center of the cathode of the inertial electrostatic confinement fusion facility.

4. The inertial electrostatic confinement fusion facility having the inner ion source according to claim 3, wherein an angular momentum of ions injected by the inner ion source can be changed from a zero angular momentum to a non-zero angular momentum, or changed from the non-zero angular momentum to a reverse angular momentum or the zero angular momentum; and if the angular momentum of the injected ions is the zero angular momentum, and the electric field perturbation device is used at the same time, the electric field perturbation device needs to be located in the slightly deviated symmetrical position on the inner ion source relative to the center of the cathode of the inertial electrostatic confinement fusion facility.

5. The inertial electrostatic confinement fusion facility having the inner ion source according to claim 2, wherein cooling channels are arranged in the longitude and latitude circles of the cathode (2); the cooling channel in the longitude circle is separated at a joint with the high-voltage lead-in support rod (3), and two ends separated are respectively connected with cooling medium input and output channels arranged in the high-voltage lead-in support rod (3); the cooling channel in the latitude circle is communicated with the cooling channel in the longitude circle; and cross-sectional sizes of the cooling channels in different latitude circles are the same or different.

6. The inertial electrostatic confinement fusion facility having the inner ion source according to claim 2, wherein the cathode (2) is provided with at least one longitude circle of the same size; the latitude circles are symmetrical in upper and lower hemispheres, more than four latitude circles are provided, and when an even number of latitude circles are provided, no latitude circle is arranged in an equator position of the cathode of the spherical net structure; and cross sections of the longitude circle and the latitude circle are in a rectangle, a long edge direction of the rectangle is a radial direction pointing to a center of sphere, and a short edge direction of the rectangle is perpendicular to the radial direction.

7. The inertial electrostatic confinement fusion facility having the inner ion source according to claim 1, wherein the inner ion source (4) is arranged inside the anode (1) of the inertial electrostatic confinement fusion facility, or arranged outside the anode (1) of the inertial electrostatic confinement fusion facility; and when the inner ion source (4) is arranged outside the anode (1) of the inertial electrostatic confinement fusion facility, the cathode (42) of the inner ion source (4) needs to penetrate through the anode (1) of the inertial electrostatic confinement fusion facility and extend into the inertial electrostatic confinement fusion facility to inject an ion beam, and a focusing magnet (7) is added outside the cathode of the inner ion source located outside the anode of the inertial electrostatic confinement fusion facility.

8. The inertial electrostatic confinement fusion facility having the inner ion source according to claim 1, wherein the inner ion source (4) is arranged on a plane perpendicular to the high-voltage lead-in support rod (3) and passing through a center of the inertial electrostatic confinement fusion facility.

9. The inertial electrostatic confinement fusion facility having the inner ion source according to claim 2, wherein a vacuum degree of a vacuum cavity is better than 10-3 Pa.

10. The inertial electrostatic confinement fusion facility having the inner ion source according to claim 1, wherein a plurality of inner ion sources (4) and a plurality of ion motion trajectory perturbation devices (5) are provided separately or simultaneously.
